(19) United States
(12) Patent Application Publication
(10) Pub. No.: US 2009/0037869 A1
(43) Pub. Date: Feb. 5, 2009

(54) System and method for evaluating a product development process

(76) Inventors: Darin Edward Hamilton, Creve Coeur, IL (US); Andy Redeker, Bavaria (DE); Camden Mark Bucey, Philadelphia, PA (US); Jason Michael Cassidy, East Peoria, IL (US); Kelly Adam Bucey, Normal, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/881,955

(22) Filed: Jul. 30, 2007

(51) Int. Cl. G06F 9/44

(52) U.S. Cl. 717/100

(57) ABSTRACT

A method for evaluating a product development process comprises defining one or more specifications associated with a product development process, wherein the product development process includes a plurality of subtasks. One or more assessment benchmarks for determining the status of each subtask are formulated and development evaluation forms associated with each subtask are generated. The development evaluation forms include an interactive interface that provides the assessment benchmarks to a product development team member associated with a respective subtask. Responses associated with the development evaluation forms are automatically detected and a status of the development process is updated based on the detected responses.

### TECHNICAL FIELD

The present disclosure relates generally to product development and, more specifically, to a software tool for evaluating the development of products during various stages of design and manufacture.

### BACKGROUND

Research and development of new products or solutions is an integral part of virtually every business. Organizations that can effectively and efficiently introduce new products or implement new technologies in the marketplace may enjoy increased market share and are often recognized by consumers as the industry leader. In fact, in many industries, investment in research and development of new products and solution may constitute a relatively large percentage of an organization's capital expenditures. Accordingly, by increasing the speed and efficiency with which new products are developed and introduced into the marketplace, organizations that rely heavily on research, development, and implementation of new technologies and solutions can increase return on their research and development investment.

In an effort to increase the speed and efficiency in the development of new products, some organizations rely on compartmentalizing and assigning development tasks to a division that is most capable of handling the task. In the development of a new automobile, for example, the design, development, and deployment of the automobile may be parsed into several components. For instance, the engine design may be assigned to a project management team uniquely capable to handle the engine design. Similarly, the electrical system may be assigned to a project management team with the appropriate capabilities to oversee the development of the electrical system. Each system or subcomponent may be divided into several subtasks, where each subtask is assigned to a particular subgroup or individual on the appropriate design team. Each task may include a product schedule with benchmark dates and development milestones, ultimately leading to production and rollout of the new product.

One such product development process is described in U.S. Pat. No. 6,901,372 (“the '372 patent”) to Helzerman. The '372 publication describes a method for coordinating phases of a multi-phase project. The method includes executing a project in five-phases including: a concept proposal phase, a concept feasibility phase, a manufacturing concept ready phase, a manufacturing implementation ready phase, and a replication phase. After the completion of each phase a review is conducted to ensure that parties involved in the development are informed about the project results, delivery dates, and action items that remain to be completed.

Traditional compartmentalized product development schemes, such as that illustrated in the '372 patent, may have several disadvantages. For example, because each development team may have a significant amount of autonomy and flexibility in conducting its own development projects, delays in the development and execution of tasks associated with one group may not be realized until late in the development process, usually when the different subcomponents of the system are integrated during the assembly and testing stages of the final product. As a result, potential customers, investors, and shareholders may not be provided with adequate notice of any project delays in order to mitigate potential damage caused by product delays.

Furthermore, although some conventional development schemes may increase coordination of various phases of product development, they may lack a centralized assessment and reporting interface that provides interactive development evaluation forms to a web-account associated with designated product development team members, detects team member responses, and automatically evaluates a status of a development process based on the detected responses. In addition, conventional systems may not automatically notify subscribers of updates and/or changes to the development evaluation forms and/or status of the project. Because many conventional systems do not provide integrated product development evaluation systems, project managers and customers that rely on periodic status updates of project development processes may be required to independently seek progress updates from individual development teams, which may be inefficient and time-consuming

The presently disclosed system and method for evaluating a product development process is directed toward overcoming one or more of the problems set forth above.

### SUMMARY OF THE INVENTION

In accordance with one aspect, the present disclosure is directed toward a method for evaluating a product development process. The method may comprise defining one or more specifications associated with a product development process, wherein the product development process includes a plurality of subtasks. One or more assessment benchmarks for determining the status of each subtask may be formulated and development evaluation forms associated with each subtask may be generated. The development evaluation forms may include an interactive interface that provides the assessment benchmarks to a product development team member associated with a respective subtask. Responses associated with the development evaluation forms may be automatically detected and a status of the development process may be updated, based on the detected responses.

According to another aspect, the present disclosure is directed toward a method for evaluating a product development process. The method may comprise receiving one or more specifications associated with a product development process in a product development server. The method may also include creating a plurality of development evaluation forms based on the received specifications, each development evaluation form including a plurality of benchmarks for determining the status of the development process. A weight factor associated with each of the plurality of benchmarks may be established. The method may further include assigning each development evaluation form to at least one product development team member, receiving responses to one or more development evaluation forms, and determining, by the product development server, a status of the development process based on the received responses to the development evaluation form. The method may also include generating a report summarizing the status of the development process.

In accordance with yet another aspect, the present disclosure is directed toward a system for evaluating a product development process. The system may comprise an input device for receiving one or more specifications associated with a product development process, an output device for providing process readiness reports to a product development subscriber, and a processor. The processor may be configured to generate a plurality of development evaluation forms based on the received specifications, each development evaluation form including a plurality of benchmarks associated with a subtask of the product development process. The processor may also be configured to assign each development evaluation form to at least one product development team member. The processor may be further configured to detect responses to one or more development evaluation forms, evaluate status of the development process based on the received responses to the development evaluation form, and generate a report summarizing the status of the development process.

### BRIEF DESCRIPTION OF THE DRAWINGS

FIG. 1 illustrates a product development environment in which processes and methods consistent with the disclosed embodiment may be implemented;

FIG. 2 provides a block diagram of an exemplary product development process in accordance with certain disclosed embodiments; and

FIG. 3 illustrates a flowchart depicting an exemplary method for evaluating product development processes, consistent with the disclosed embodiments.

### DETAILED DESCRIPTION

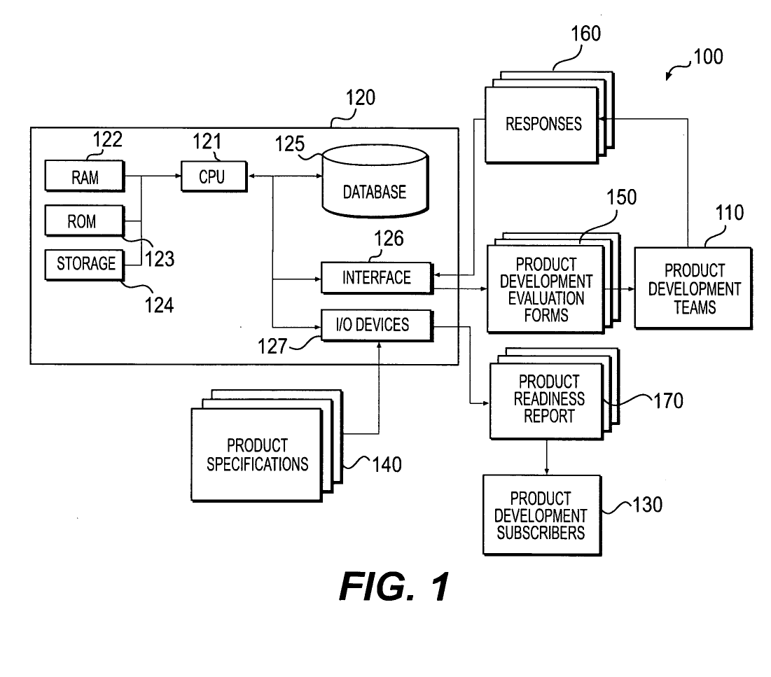

FIG. 1 illustrates an exemplary product development environment 100 in which processes and methods consistent with the disclosed embodiments may be implemented. Specifically, product development environment 100 may include any environment that facilitates design, development, and implementation of new products or solutions into the marketplace. As illustrated in FIG. 1, product development environment 100 may include one or more product development teams 110, each development team responsible for performing a subtask associated with the product development process. Product development environment 100 may also include a product development server 120 in communication with the one or more product development teams 110 and configured to evaluate and analyze subtasks performed by product development teams 100 and report the analysis results to one or more product development subscribers 130.

Product development teams 110 may each correspond to an entity responsible for design, development, implementation, and/or execution of a portion of a product development process. For example, in development environments involving the design and implementation of an earth-moving machine system, a plurality of product development teams may be employed, each development team responsible for one or more aspects of the design process. Thus, a first product development team may be responsible for the design and implementation of the machine's hydraulic system, a second product development team may be responsible for designing the machine's electrical system, and a third product development team may be responsible for the design and implementation of the machine's engine system. Each development team may be subdivided into a plurality of smaller development groups, whereby subtasks of the development team may be delegated to one or more individual team members.

Each of product development teams 110 may be responsible for managing the day-to-day operations and overseeing the progress of the particular portion of the development process to which they are assigned. Furthermore, each of product development teams 110 maybe responsible for ensuring that the product development process assigned to them progresses according to a product schedule.

Product development server 120 may include any type of processor-based system on which processes and methods consistent with the disclosed embodiments may be implemented. As illustrated in FIG. 1, product development server 120 may include one or more hardware and/or software components configured to execute software programs, such as software for managing product development environment 100. For example, product development server 120 may include one or more hardware components such as, for example, a central processing unit (CPU) 121, a random access memory (RAM) module 122, a read-only memory (ROM) module 123, a storage 124, a database 125, an interface 126, and one or more input/output (I/O) devices 127. Alternatively and/or additionally, product development server 120 may include one or more software components such as, for example, a computer-readable medium including computer-executable instructions for performing methods consistent with certain disclosed embodiments. It is contemplated that one or more of the hardware components listed above may be implemented using software. For example, storage 114 may include a software partition associated with one or more other hardware components of product development server 120. Product development server 120 may include additional, fewer, and/or different components than those listed above. It is understood that the components listed above are exemplary only and not intended to be limiting.

CPU 121 may include one or more processors, each configured to execute instructions and process data to perform one or more functions associated with product development server 120. As illustrated in FIG. 1, CPU 121 may be communicatively coupled to RAM 122, ROM 123, storage 124, database 125, interface 126, and I/O devices 127. CPU 121 may be configured to execute sequences of computer program instructions to perform various processes, which will be described in detail below. The computer program instructions may be loaded into RAM for execution by CPU 121.

RAM 122 and ROM 123 may each include one or more devices for storing information associated with an operation of product development server 120 and/or CPU 121. For example, ROM 123 may include a memory device configured to access and store information associated with product development server 120, including information for identifying, initializing, and monitoring the operation of one or more components and subsystems of product development server 120. RAM 122 may include a memory device for storing data associated with one or more operations of CPU 121. For example, ROM 123 may load instructions into RAM 122 for execution by CPU 121.

Storage 124 may include any type of mass storage device configured to store information that CPU 121 may need to perform processes consistent with the disclosed embodiments. For example, storage 124 may include one or more magnetic and/or optical disk devices, such as hard drives, CD-ROMs, DVD-ROMs, or any other type of mass media device.

Database 125 may include one or more software and/or hardware components that cooperate to store, organize, sort, filter, and/or arrange data used by product development server 120 and/or CPU 121. For example, database 125 may include specifications for service requirements associated with one or more previously implemented service processes related to a previously executed service agreement. CPU 121 may access the information stored in database 125 for comparing proposed service requirements with existing or previously implemented service requirements to determine a level of new content that may be required to implement and execute a proposed service agreement. It is contemplated that database 125 may store additional and/or different information than that listed above.

Interface 126 may include one or more components configured to transmit and receive data via a communication network, such as the Internet, a local area network, a workstation peer-to-peer network, a direct link network, a wireless network, or any other suitable communication platform. For example, interface 126 may include one or more modulators, demodulators, multiplexers, demultiplexers, network communication devices, wireless devices, antennas, modems, and any other type of device configured to enable data communication via a communication network.

I/O devices 127 may include one or more components configured to communicate information with users associated with product development server 120. For example, I/O devices may include a console with an integrated keyboard and mouse to allow users to input parameters associated with product development server 120; I/O devices 127 may also include a display including a graphical user interface (GUI) for outputting information on a monitor. I/O devices 127 may also include peripheral devices such as, for example, a printer for printing information associated with product development server 120, a user-accessible disk drive (e.g., a USB port, a floppy, CD-ROM, or DVD-ROM drive, etc.) that allows users to input data stored on a portable media device, a microphone, a speaker system, or any other suitable type of interface device.

Product development server 120 may include software and/or a web-based interface that allows users to create customized readiness assessment forms for evaluating progress of a product development process. These forms may be periodically provided to or accessible by one or more product development teams 110 for completion at various phases during the development of a product, process, or solution. Once completed the readiness assessment forms may be provided to a product development server 120, which may analyze the completed data and determine a status of the progress of the product development process.

Product development server 120 may be configured to receive or collect one or more specifications 140 associated with a product for development in product development environment 100. For example, a product manufacturer or designer may develop a concept for a new product or solution that addresses a particular customer or market need. The product manufacturer may devise product specifications 140 associated with the product that meets this need. The product specifications 140 may be provided to product development server 120 via I/O devices 127.

Product development server 120 (with the help of a product manager (not shown)) may generate a product development process to design, test, develop, and implement the product or solution according to the product specifications. The product development process may include one or more subtasks to be performed in connection with the development project. Each subtask may be divided into phases, each phase including a plurality of development benchmarks that must be met in order for the project to proceed to a subsequent phase of development. In addition, the product development process may also establish one or more product development teams, each team configured to perform one or more subtasks associated with the development process.

Product development server 120 may be configured provide product development evaluation forms 150 to product development teams 120 at various stages of the product development process. Product development evaluation forms 150 may include one or more interactive software interfaces that prompt members of project development teams 120 to provide feedback associated with the progress of a particular subtask. According to one embodiment, product development evaluation forms 150 may include electronic checklists that periodically present product development teams 110 with the plurality of predetermined benchmarks associated with the development stage of the subtask.

According to one embodiment, product development server 120 may store product development evaluation forms 150 in database 125. Authorized product development team members may login to product development server 120 in order to access one or more of the product development evaluation forms via interface 126. Once a product development team member's identity is authenticated by interface 126, product development server 120 may provide one or more product development evaluation forms 150 to the team member for review and completion.

Alternatively and/or additionally, product development server 120 may provide product development evaluation forms 150 to one or more product development teams 110 electronically, via electronic mail or other electronic file transfer medium. For example, product development server 120 may include an integrated electronic mail service that periodically provides product development evaluation forms to the appropriate product development team or team member.

Product development server 120 may receive/collect responses 160 to the product development evaluation forms from each of product development teams 110. According to one embodiment, product development server 120 may receive completed development evaluation forms 150 electronically from one or more product development teams 110. Alternatively and/or additionally, product development server 120 may detect changes or updates to the product development evaluation forms stored in database 125.

Product development server 120 may be configured to analyze the product development evaluation forms, determine a status of the product development process, update product development parameters based on the status of the product development process, and provide a product readiness report 170 to one or more product subscribers 130 associated with product development environment. According to one embodiment, product development server 120 may include a computer readable medium with software executable instructions for analyzing the received product development evaluation forms and, based on the analysis, determine whether a product development process is ready to proceed to a subsequent development phase. The software may also be configured to generate a product readiness assessment report 170 associated with the analysis and deliver the report to one or more product subscribers 130.

Product subscriber 130 may include one or more computer systems configured to receive data from product development server 120. For example, product subscriber 130 may include one or more computer systems associated with a particular division of a business entity associated with product development environment 100 such as, for example, a product management division, a human resources division, a sales division, one or more product dealers, one or more product development teams, or any other entity that may be associated with product development environment 100. According to one embodiment, product subscriber 130 may receive product readiness reports 170 from product development server 110, the product readiness reports 170 summarizing the status of the product development process and subtasks or sub-processes associated therewith.

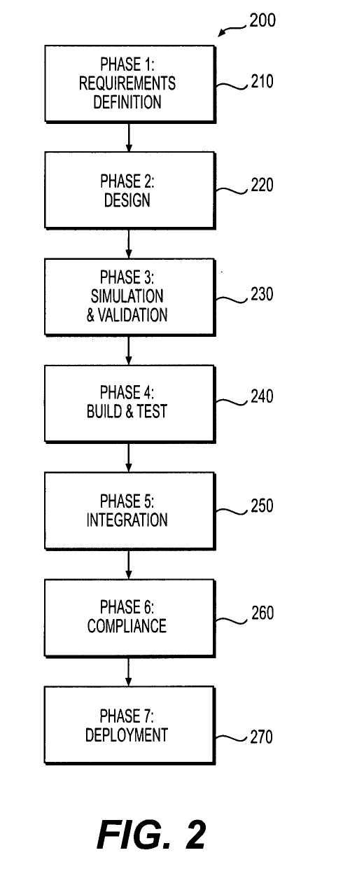

Processes and methods consistent with the disclosed embodiments provide a solution that allows users to create an interactive product development evaluation tool that analyzes a product development process during various phases of implementation and determines, based on predetermined process benchmarks, whether the development process is ready to proceed to subsequent stages of development. FIG. 2 depicts a flowchart 200 illustrating phases associated with an exemplary development process.

As illustrated in FIG. 2, the initial phase of a product development process or subtask associated therewith may include the requirements definition phase (Step 210). The requirements definition phase may embody a process whereby the product development manager or product development team defines the various design requirements of a particular subtask. The requirements definition phase may include identifying and outlining various design limitations, standards, or regulations set forth by one or more governmental or regulating organizations. For example, for an engine design subtask for an equipment system development project, the requirements definition phase may include identifying any emissions regulations, safety standards, fuel consumption regulations, etc. set forth by one or more regulating bodies.

Once a requirements definition phase has been completed, the process may proceed to a design phase (Step 220). During the design phase, one or more product development teams and personnel associated therewith may design the product, process, or solution in accordance with the parameters set forth in the requirements definition phase and/or the target performance specifications established by the product development process specifications.

Once the design phase is complete, a product development process may proceed to the simulation and validation phase (Step 230). During the simulation and validation phase, a prototype or model of the product design may be constructed. According to one embodiment, the model may be constructed using one or more computer-based analysis and simulation tools. The design may be tested under a variety of simulated environments to ensure that the design meets the desired specifications set for in the requirements definition phase. If, after simulation, the design complies with the defined requirements the design may be validated.

Once the design had been simulated and validated, the product development process may proceed to the build and test phase (Step 240). During this phase, the product may be physically built according to the design specifications and tested in “real world” conditions that are indicative of the operational environment in which the product may be implemented. For example, one or more of the designed components may be constructed and installed in a test machine operating in a machine design environment. The test machine may then be operated for several hours, during which operational aspects of the installed components may be monitored, recorded, and analyzed, to ensure that the product design performs in accordance with the design specifications and requirements.

Upon successful completion of the build and test phase, the component may be integrated within the system in which it will be deployed (Step 250). Accordingly, the overall system may be tested for compliance with the design specifications of the system (Step 260). Once compliance of the overall system has been verified, the product may be released for deployment (Step 270) for mass production and manufacture. The deployment process may include developing a manufacturing schedule, whereby older designs may be gradually phased out in support of the new product, ultimately resulting in the full release of the product to consumers.

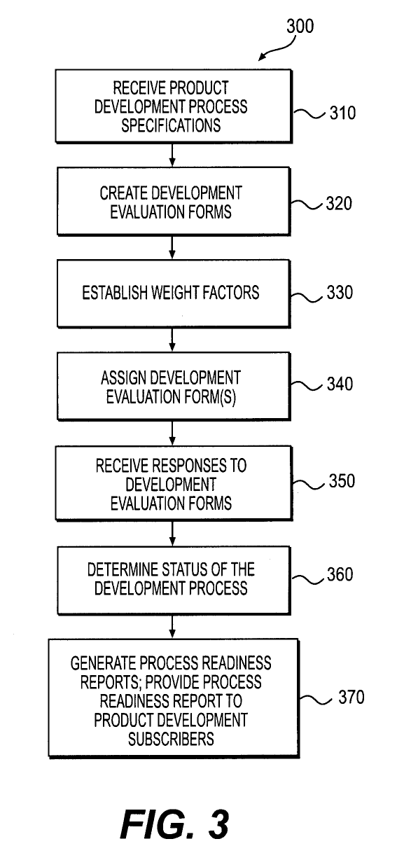

Features and methods described herein create a plurality of interactive product evaluation summaries; solicit responses to the product evaluation summaries from one or more product development team members; detect responses to the product development evaluation forms; and update the status of the product development process based on the detected responses. FIG. 3 provides a flowchart 300 depicting an exemplary method for evaluating a product development process consistent with the disclosed embodiments.

As illustrated in FIG. 3, product development server 120 may receive one or more specifications associated with a product development process (Step 310). Product development process specifications may include any aspect associated with a product or solution for development and implementation by product development environment 100. For example, these specifications may include a target product release date, operational tolerances associated with the finished product, functional aspects or parameters associated with the finished product, or any other type of design requirement associated with a product or system. These product development process specifications may provide baseline parameters for creating a product development process. For example, a product manager or product development team may establish a product development schedule, define subtasks associated with the product development, assign subtasks to the appropriate product development team, and/or establish design benchmarks associated with each subtask.

Once product development specifications have been received and a product development process defined, one or more product development evaluation forms may be created (Step 320). According to one embodiment, a development manager in charge of the overall product development process may parse the product development process into a plurality of subtasks and assign each subtask to one or more product development teams 110 associated with product development environment 100. The development manager, with the aid of each product development team, may devise a development schedule for each subtask, the development schedule including a plurality of different development phases. Each development phase may include one or more milestones and/or performance benchmarks that must be met before the development process can proceed to the next phase of the subtask.

A product development manager or product development team may define performance benchmarks for measuring and/or analyzing product development processes. According to one embodiment, performance benchmarks may be in the form of one or more predetermined questions. These questions may be “yes/no” questions, “true/false” questions, or questions with a limited number of predetermined choices. Each of these questions may be directed toward a particular development aspect associated with one or more subtasks of the product development process. Performance benchmarks may be established for each phase of the development process and may be integrated to create development evaluation forms for the overall product development process.

By way of example, a requirement definition phase for an engine system may include performance benchmark questions or checklists that require verification that a plurality of applicable engine safety standards, emission requirements, and/or fuel economy requirements have been consulted, and that any design specifications conform to the applicable standards. For example, certain engine systems must adhere to emission requirements established by a government regulatory body (e.g., federal or state environmental boards, etc.) One or more checklist-type performance benchmarks may be established to ensure that any applicable emission requirements have been addressed in the requirements definition phase.

As explained, product development evaluation forms may embody interactive checklists that present users with performance benchmarks via an interactive interface. According to one exemplary embodiment, the product evaluation forms may be stored on a web-server. Each form may be accessible by designated product development team members responsible for the performance of the portion of the process associated with a particular form. As such, users may periodically log into the web interface and complete/modify responses to a portion of the product evaluation form, during performance of the product development process.

Once development evaluation criteria have been established, weight factors associated with each of the performance benchmarks may be established (Step 330). These weight factors may define the relative impact that a particular performance benchmark may have on the readiness of the product development process to progress to a subsequent phase of development. Those skilled in the art will recognize that certain aspects of a particular development phase are more critical in the overall success of the project. As such, each performance benchmark may be assigned a weight factor. According to one embodiment, weight factors may include a numerical ranking system wherein each performance benchmark is assigned a numerical value within a predetermined range (e.g., from 1 to 10, etc.) corresponding to the impact of the benchmark on the process readiness determination. The higher the assigned value, the greater impact that a positive response to the performance benchmark has on the process readiness determination.

For instance, following the example above, certain safety standards may be defined by a government regulatory agency that will not allow commercial release of a product unless the safety standards are complied with. Accordingly, performance benchmarks associated with these standards may be assigned weight factors indicative of the importance of compliance with these standards in the overall success of the product development process. Similarly, certain design goals or targets may not be particularly critical in the overall success of the project development phase. Accordingly, performance benchmarks corresponding to these design goals may be assigned a weight factor indicative of the relatively low importance of the performance benchmark on the overall readiness of the phase to proceed to a subsequent phase of development.

Once development evaluation forms have been created and weight factors associated with each benchmark assigned, development evaluation forms may be assigned to an appropriate project development group and/or team member (Step 340). For example, a product development manager may identify a particular design group that may be suited to complete a subtask of the product development process. The product development manager may select members of the product development team from a centralized personnel directory (e.g., corporate email directory). Alternatively, the product development manager may designate a product development team leader, who may subsequently assign individual team members to particular subtasks associated with the development process.

According to one embodiment, product development server 120 may notify product development team members to which development evaluation forms have been assigned. The notification may include a development schedule that includes product development milestone dates, including deadlines for responding to product development evaluation forms. In addition, product development server 120 may provide periodic reminders to development team members of upcoming product development milestones and deadlines for completing development evaluation forms. For example, product development server 120 may monitor the product development evaluation forms and identify evaluation forms that have not been completed. Product development server 120 may automatically provide an email reminder to any product development team members associated with evaluation forms that have not been completed.

Product development server 120 may be configured to receive responses to development evaluation forms completed by product development team members (Step 350). For example, software associated with product development server 120 may poll evaluation forms stored in database 125, detect changes to the evaluation forms, authenticate the responses to ensure that authorized personnel provided the responses, and download data associated with the responses. Alternatively and/additionally, evaluation forms may be received from individual team members via email or other electronic format. The responses may be automatically uploaded onto a master version of the evaluation form, so that product development progress for the entire development process may be evaluated.

Once responses to the development evaluation forms have been received, product development server may compile the responses and evaluate the status of the development process based on the responses (Step 360). For example, each performance benchmark response may correspond to a particular numerical value that, when adjusted by the weight factor assigned to the particular performance benchmark, may constitute a score for the particular response. For instance, when evaluating an engine development process in the requirements definition phase, one or more performance benchmarks may be directed to determining whether appropriate emission standards have been consulted. A “No” response may be assigned a value of “0”, while a “Yes” response may be assigned a value of 1. This value may be multiplied by the assigned weight factor to determine the response score.

Once each of the response scores for the individual performance benchmarks have been tabulated, an overall process readiness score for the development phase may be calculated. According to one embodiment, the response scores for the individual performance benchmarks associated with the evaluation form may be added together to determine the phase readiness score associated with the particular development phase.

This phase readiness score may be compared with a threshold level, to determine if the particular task can proceed to the next phase of development. If the phase readiness score exceeds the threshold level, for example, project development server 120 may allow commencement of the next development phase. If, on the other hand, the development score is less than the threshold level, product development server 120 may require that the development process remain in the current development phase until appropriate action has been taken to ensure that the product complies with the development specifications before proceeding.

Once one or more processes have been evaluated, project management server 120 may evaluate the overall status of the development project (Step 360). The status may depend upon the collective readiness assessment scores for the individual subtasks. The status may include a cumulative process readiness score, which may be indicative of compliance of the product development process with the product development specifications. The status of the development project may also include an updated product development schedule, including revised product development timelines. Those skilled in the art will recognize that product development schedules may be adjusted to compensate for schedule modifications of individual subtasks.

Upon evaluating the overall status of the development project, product development server 120 may generate a process readiness report summarizing the status of the product development process (Step 370). This report may include readiness scores associated with individual subtasks and phases of development. In addition, the report may include recommendations for improving process compliance and readiness scores by adjusting certain aspects of the product development cycle, based on historical product development analysis.

Product development server 120 may provide the process readiness report to one or more product development subscribers. Product development subscribers may include product development teams, product sales and marketing divisions, a human resource division, or any other persons or business entities designated to receive the reports. For example, product development server 120 may provide the process readiness report to a sales and marketing division so that dealers and customers may be notified of product release schedules.

In another example, process readiness reports may be provided to a human resources division. The human resources division may use the process readiness information for evaluating particular needs within product development teams. For example, should one product development team consistently “fail” process readiness evaluations, a human resources division may be able to take measures to ensure that the development team has the resources and personnel needed to meet process readiness benchmarks. This may include, for example, hiring additional team members, scheduling training sessions to enhance technical capabilities and/or project management skills, or providing incentives (e.g., performance-based compensation, etc.) for development team members who meet the product development deadlines and readiness goals.

In addition, product development server 120 may allow individual product development subscribers to customize the format of product development reports. For example, a sales and marketing division may only be concerned with changes to the product development schedule that affect the final product release date. Accordingly, the product development report for the sales and marketing division may be customized to filter out any data not related to changes in the product release date.

Although the methods and processes described above are described as being performed by a computer-based product development server and/or software associated therewith, it is contemplated that certain method steps may be performed manually and/or using a combination of manual and computer-based methods.

### INDUSTRIAL APPLICABILITY

Methods and systems consistent with the disclosed embodiments may provide an automated solution for monitoring the incremental progress of a product development process. This solution may involve creating interactive development evaluation forms that may be periodically polled by a product development server 120 to update a status of the product development process. This automated solution may be fully integrated with an organization's messaging services so that product development updates, status reports, product development deadlines, and other aspects of the development process may be automatically distributed to any user-designated product development subscribers. Features consistent with the disclosed embodiments may eliminate the need for product development managers to perform routine product development tasks, such as collecting product evaluation data from individual teams or team members, providing development milestone reminders to team members, and customizing reports for individual product subscribers.

Although the disclosed embodiments are described in relation to development processes associated with the manufacture of machine components, they may be applicable to any development environment. For example, features associated with the embodiments described herein may be used in the development of software products, work flow processes, or any other environment where it may be advantageous to periodically evaluate progress of a design project to ensure compliance with predetermined benchmarks before proceeding to more advanced stages of deployment. As a result, problems encountered in early stages of development may be identified and resolved prior to investing additional development resources.

The presently disclosed product development evaluation process may have several advantages. For example, because evaluation processes described herein provide an automated system that periodically polls product evaluation forms, automatically detects changes to the development forms, and automatically performs a process readiness assessment based on the detected changes, product subscribers may receive “real-time” or “near real-time” status updates during the development of the product. Accordingly, the presently disclosed evaluation process allows product managers, shareholders, and customers may stay informed of new product developments without having to manually request status updates from individual product development teams.

In addition, because the product development evaluation processes described herein may automatically and objectively determine whether a particular development task is ready to proceed to subsequent phases of development, problems associated with product development may be detected early in the development process. As a result, development delays may be more quickly identified and accurately predicted, allowing product managers greater flexibility in dedicating development resources to ensure that the overall product development process remains on schedule.

It will be apparent to those skilled in the art that various modifications and variations can be made to the disclosed system and method for evaluating a product development process without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for evaluating a product development process comprising:
defining one or more specifications associated with a product development process, the product development process including a plurality of subtasks;
formulating one or more assessment benchmarks for determining the status of each subtask;
generating a development evaluation form associated with each subtask, the development evaluation form including an interactive interface that provides the assessment benchmarks to a product development team member associated with a respective subtask;
posting the development evaluation form associated with each subtask to an interactive web-interface;
detecting responses to the development evaluation forms;
calculating a process readiness score associated with one or more subtasks of the development process based on the detected responses; and
updating a status of the development process based on the process readiness score for each subtask.

2. The method of claim 1, further including analyzing historical data associated with the development process, wherein one or more assessment benchmarks are based on the historical data associated with the development process.

3. The method of claim 2, further including establishing a weight factor associated with each of the plurality of benchmarks, wherein one or more weight factors is based on the historical data.

4. The method of claim 1, wherein updating the status of the development process further includes:
comparing the process readiness score associated with one or more subtasks with a threshold readiness level corresponding to the subtask; and
providing a process advancement authorization if the process readiness score associated with the subtask exceeds a threshold readiness level.

5. The method of claim 4, wherein updating the status of the development process further includes providing an indication that subtask is not ready to advance to a higher level of development if the process readiness score associated with the subtask is less than the threshold readiness level.

6. A method for evaluating a product development process comprising:
receiving one or more specifications associated with a product development process in a product development server;
creating a plurality of development evaluation forms based on the received specifications, each development evaluation form including a plurality of benchmarks for determining the status of the development process;
assigning a development evaluation form to at least one product development team member;
receiving responses to one or more development evaluation forms;
determining, by the product development server, a status of the development process based on the received responses to the one or more development evaluation forms; and
generating a report summarizing the status of the development process.

7. The method of claim 6, wherein creating a plurality of development evaluation forms includes:
analyzing historical data associated with the development process; and
formulating one or more of the benchmarks of the development evaluation form based on the historical data.

8. The method of claim 7, further including establishing a weight factor associated with each of the plurality of benchmarks based on the historical data.

9. The method of claim 6, wherein creating a plurality of development evaluation forms includes:
parsing the product development process into a plurality of subtasks;
establishing one or more assessment benchmarks for determining the status of each subtask; and
generating a development evaluation form associated with each subtask, the development evaluation form including an interactive interface that provides the assessment benchmarks to the product development team member associated with the development evaluation form.

10. The method of claim 6, wherein assigning each development evaluation form to at least one development team member includes:
posting each development evaluation form to one or more web-accessible accounts associated with the at least one team member; and
identifying product development personnel authorized to respond to each development evaluation form.

11. The method of claim 10, wherein receiving responses to one or more development evaluation forms includes:
periodically monitoring the development evaluation forms posted to the one or more web-accessible accounts;
detecting one or more responses provided to the development evaluation forms; and
updating the status of the development process based on the detected responses.

12. The method of claim 11, wherein evaluating the status of the development process includes calculating a process readiness score associated with one or more subtasks of the development process based on the detected responses.

13. The method of claim 6, wherein generating a report includes providing the report to one or more subscribers associated with the product development process.

14. A system for evaluating a product development process comprising:
an input device for receiving one or more specifications associated with a product development process;
an output device for providing process readiness reports to a product development subscriber;
a processor configured to:
generate a plurality of development evaluation forms based on the received specifications, each development evaluation form including a plurality of benchmarks associated with a subtask of the product development process;
assigning a development evaluation form to at least one product development team member;
detect responses to one or more development evaluation forms;
evaluate status of the development process based on the received responses to the development evaluation form; and
generate a report summarizing the status of the development process.

15. The system of claim 14, wherein generating a plurality of development evaluation forms includes:
analyzing historical data associated with the development process; and
formulating one or more of the benchmarks of the development evaluation form based on the historical data.

16. The system of claim 14, wherein generating a plurality of development evaluation forms includes:
parsing the product development process into a plurality of subtasks;
establishing one or more assessment benchmarks for determining the status of each subtask; and
generating a development evaluation form associated with each subtask, the development evaluation form including an interactive interface that provides the assessment benchmarks to the product development team member associated with the development evaluation form.

17. The system of claim 14, wherein assigning each development evaluation form to at least one development team member includes:
posting a development evaluation form to a web-accessible accounts associated with the at least one team member; and
identifying product development personnel authorized to respond to each development evaluation form.

18. The system of claim 17, wherein receiving responses to one or more development evaluation forms includes:
periodically monitoring the development evaluation forms posted to the one or more web-accessible accounts;
detecting one or more responses provided to the development evaluation forms; and
updating the status of the development process based on the detected responses.

19. The system of claim 18, wherein evaluating the status of the development process includes calculating a process readiness score associated with one or more subtasks of the development process based on the detected responses.

20. The system of claim 14, wherein generating a report includes providing the report to one or more subscribers associated with the product development process.
